(19) United States
(12) Patent Application Publication
(10) Pub. No.: US 2003/0116245 A1
(43) Pub. Date: Jun. 26, 2003

(54) Tire breaker and anti-knock arrangement

(76) Inventor: Shut Chen Hsu, I Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/022,424

(22) Filed: Dec. 20, 2001

(51) Int. Cl. B60C 17/04; B60C 17/00; B60C 5/16

(52) U.S. Cl. 152/158; 152/165; 152/520; 152/391; 152/400

(57) ABSTRACT

A tire breaker and anti-knock arrangement includes a supplementary bearing structure formed of two parallel supplementary bearing loops supported inside the tire between two inward lips at two sidewalls of the tire for enabling the driver to keep driving the car to a repair shop upon a tire explosion due to an accident.

### BACKGROUND OF THE INVENTION

1. Field of the Invention

The present invention relates to vehicle tires and, more particularly, to a tire breaker and anti-knock arrangement, which protects the tire against piercing of external sharp objects.

2. Description of the Related Art

For a safety driving, the condition of vehicle tires must be regularly checked. There are two kinds of vehicle tires used in existing motorcars, namely, the tire having an inner tube, and the tire without inner tube. According to conventional tire designs, a meshed metal wire structure formed of transverse metal wires and a longitudinal metal wires is arranged in between the carcass and the tread. The two layers of metal wires are arranged at 17˜26°. This meshed metal wire structure can only reinforce the structural strength of the tire. It cannot protect the tire against piercing of an external sharp object. When a nail or the like pierced through the open spaces in the meshed metal wire structure, the tire leaks, and a tire explosion accident may occur.

### SUMMARY OF THE INVENTION

The present invention has been accomplished to provide a tire, which eliminates the aforesaid problems. According to one aspect of the present invention, the tire breaker and anti-knock arrangement comprises a tire, the tire having two inward lips respectively protruded from two opposite sidewalls thereof at an inner side, and a supplementary bearing structure supported inside the tire between the inward lips for enabling the driver to keep driving the car to a repair shop upon a tire explosion due to an accident. According to another aspect of the present invention, the supplementary bearing loop comprises two supplementary bearing loops each formed of a plurality of arched bearing members connected in series, a plurality of compression springs respectively connected between the arched bearing members of the supplementary bearing loops, and two annular flexible packing rings respectively fastened to the inward lips and the supplementary bearing loops.

### BRIEF DESCRIPTION OF THE DRAWINGS

FIG. 1 is a sectional elevation of a tire constructed according to the present invention.

FIG. 2 is an exploded view of a part of a supplementary bearing structure according to the present invention.

FIG. 3 is a schematic drawing showing the structure of one supplementary bearing loop for the supplementary bearing structure according to the present invention.

FIG. 3A is a schematic drawing showing the structure of a peripherally slotted annular flexible packing ring for the supplementary bearing structure according to the present invention.

FIG. 4 is a cross sectional view of the present invention, showing the supplementary bearing structure installed in the tire, the tire installed in the wheel rim.

FIG. 5 is an exploded view of a part of an alternate form of the supplementary bearing structure according to the present invention.

FIG. 6 is a cross sectional view of the present invention, showing the alternate form of the supplementary bearing structure installed in the tire, the tire installed in the wheel rim.

### DETAILED DESCRIPTION OF THE PREFERRED EMBODIMENT

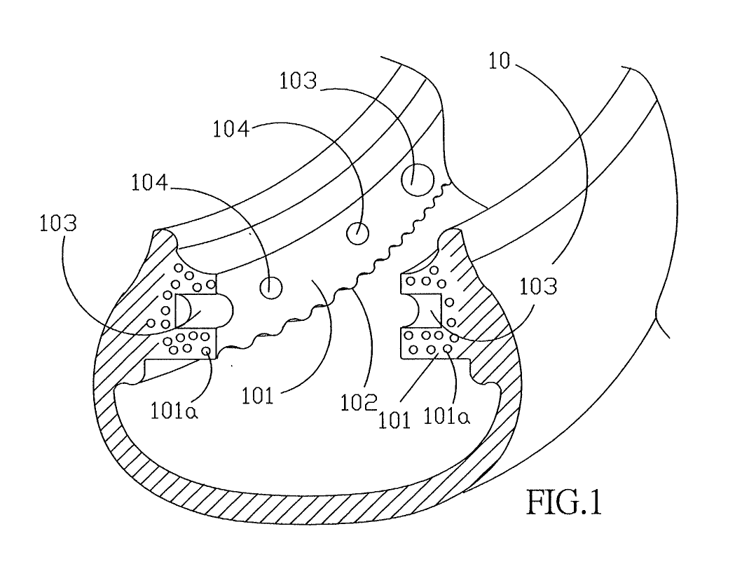

Referring to FIG. 1, the tire 10 comprises two inward lips 101 respectively inwardly protruded from the two opposite sidewalls thereof, and reinforcing wires 101a embedded in the inward lips 101. The inward lips 101 have a corrugated bottom sidewall 102, and a plurality of locating holes 103 and plugholes 104.

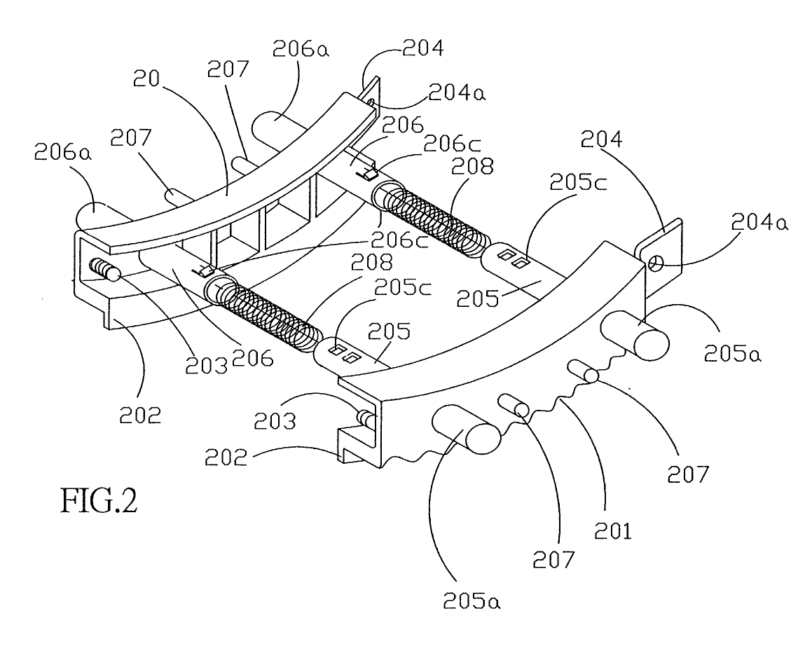

Referring to FIGS. 2, 3, 3A, and 4, a supplementary bearing structure 2000 is mounted in the tire 10, and then fastened with the tire 10 to a wheel rim 50. The supplementary bearing structure 2000 comprises two supplementary bearing loops each formed of a plurality of arched bearing members 20 connected in series, a plurality of compression springs 282 respectively connected between the arched bearing members 20 of the supplementary bearing loops, and two peripherally slotted annular flexible packing rings 30 respectively fastened to the inward lips 101 and the supplementary bearing loops of the arched bearing members 20.

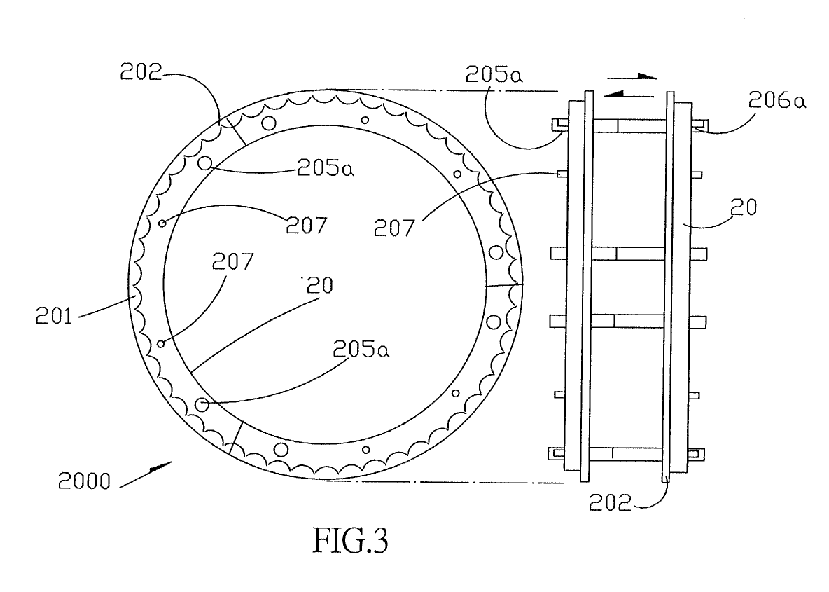

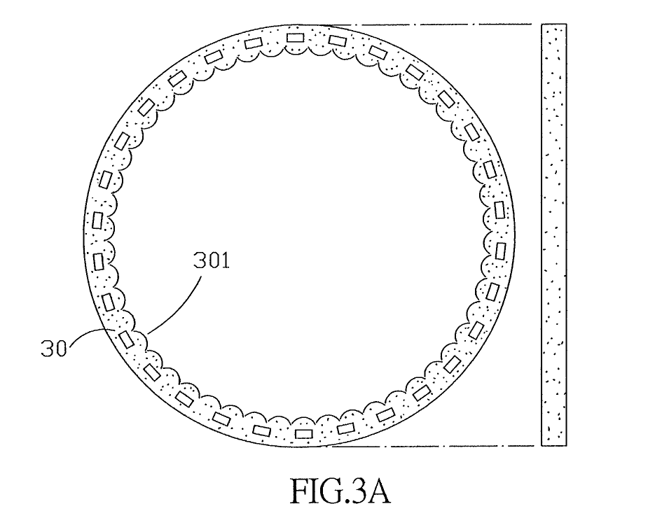

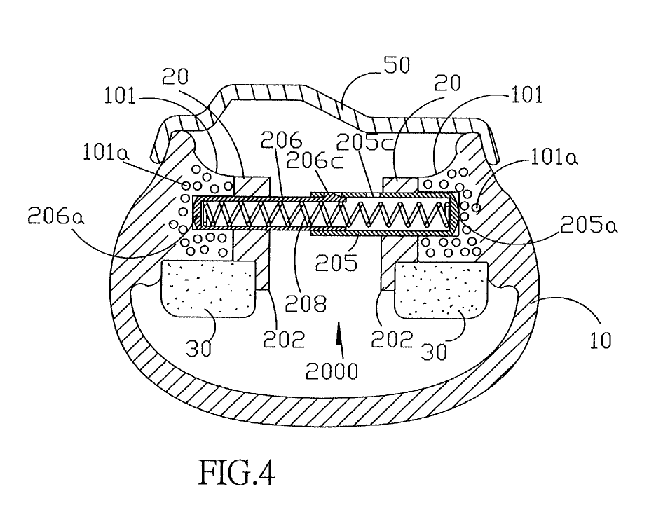

Referring to FIGS. 3A and 4 again, each annular flexible packing ring 30 has a corrugated inner diameter 301 fitting the corrugated bottom sidewall 102 of one inward lip 101 of the tire 10.

Referring to FIGS. 2, 3, and 4 again, the arched bearing members 20 each comprise a corrugated bottom sidewall 201 fitting the corrugated inner diameter 301 of the corresponding annular flexible packing ring 30, a downward stop flange 202 stopped at one side of the corresponding annular flexible packing ring 30, a screw rod 203 disposed at one end, a coupling lug 204 disposed at the other end and defining a coupling hole 204a, which receives the screw rod 203 of another arched bearing members 20, a plurality of plug rods 207 and locating rods 205a and 206a respectively press-fitted into corresponding plugholes 104 and locating holes 103 in the inward lips 101 of the tire 10, and coupling tubes 205a or 206a. The coupling tubes 205 of the arched bearing members 20 of one supplementary bearing loop each have a longitudinal series of hook holes 205c. The coupling tubes 206 of the arched bearing members 20 of the other supplementary bearing loop each have a hook 206c. The coupling tubes 206 of the arched bearing members 20 of one supplementary bearing loop are respectively inserted into the coupling tubes 205 of the arched bearing members 20 of the other supplementary bearing loop, enabling the hooks 206c to be selectively hooked in the hook holes 205c. The compression springs 208 are respectively mounted in the coupling tubes 206 of the arched bearing members 20 of one supplementary bearing loop and the coupling tubes 205 of the arched bearing members 20 of the other supplementary bearing loop.

In case the tire 10 exploded due to an accident, the supplementary bearing structure 200 supports the tire 10 in shape, enabling the car to be continuously driven to the repair shop safely to receive a repair.

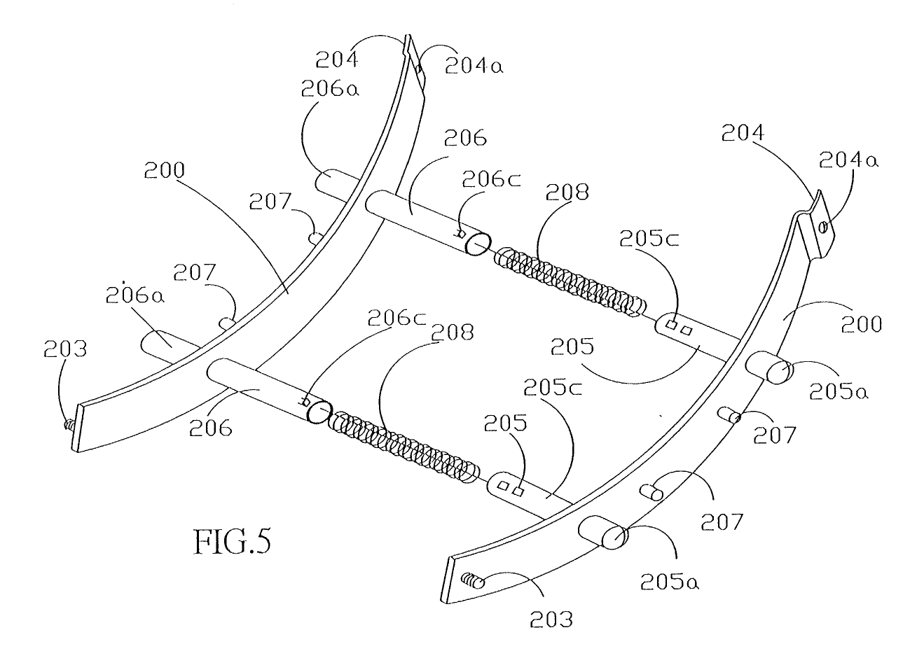

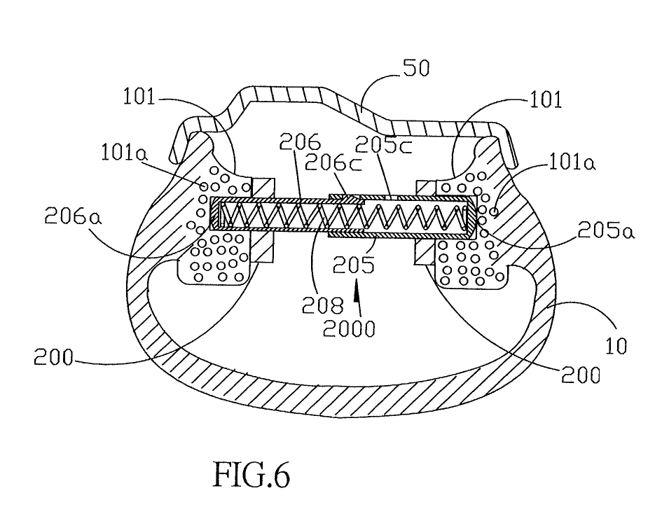

FIGS. 5 and 6 show an alternate form of the present invention. According to this embodiment, the inward lips 101 of the tire 10 are made relatively thicker than the aforesaid first embodiment of the present invention, and the aforesaid flexible annular packing rings 30 are eliminated.

It is to be understood that the drawings are designed for purposes of illustration only, and are not intended for use as a definition of the limits and scope of the invention disclosed.

What the invention claimed is:

1. A tire breaker and anti-knock arrangement comprising:
a tire, said tire comprising two inward lips respectively protruded from two opposite sidewalls thereof at an inner side, said inward lips comprising a plurality of plugholes and locating holes; and
a supplementary bearing structure supported inside said tire between said inward lips, said supplementary bearing loop comprising two supplementary bearing loops each formed of a plurality of arched bearing members connected in series, a plurality of compression springs respectively connected between said arched bearing members of said supplementary bearing loops, and two annular flexible packing rings respectively fastened to said inward lips and said supplementary bearing loops, said annular flexible packing rings each having a corrugated inner diameter fitting the corrugated bottom sidewalls of said inward lips of said tire, said arched bearing members each comprising a corrugated bottom sidewall fitting the corrugated inner diameter of said annular flexible packing rings, a downward stop flange stopped at one side of the corresponding annular flexible packing ring, a screw rod disposed at one end, a coupling lug disposed at the other end and defining a coupling hole, which receives the screw rod of another arched bearing members, a plurality of plug rods and locating rods respectively press-fitted into the plugholes and locating holes in said inward lips of said tire, and coupling tubes, the coupling tubes of. the arched bearing members of one of said supplementary bearing loops each having a longitudinal series of hook holes, the coupling tubes of the arched bearing members of the other of said supplementary bearing loops each having a hook adapted for selectively hooking in said hook holes, the coupling tubes of the arched bearing members of one of said supplementary bearing loops being respectively inserted into the coupling tubes of the arched bearing members of the other of said supplementary bearing loops, said compression springs being respectively mounted in the coupling tubes of the arched bearing members of said supplementary bearing loops.
